(19) United States
(12) Patent Application Publication
(10) Pub. No.: US 2026/0228548 A1
(43) Pub. Date: Aug. 6, 2026

(54) DATA ANALYSIS DEVICE, DISPLAY DEVICE, DATA ANALYSIS METHOD, AND RECORDING MEDIUM

(71) Applicant: NEC Corporation, Tokyo (JP)

(72) Inventor: Takuya HIRAOKA, Tokyo (JP)

(73) Assignee: NEC Corporation, Tokyo (JP)

(21) Appl. No.: 19/149,955

(22) PCT Filed: Jan. 25, 2023
(86) PCT No.: PCT/JP2023/002261

§ 371 Date: Jul. 22, 2025

(51) Int. Cl. G06N 3/092

(52) U.S. Cl. CPC G06N 3/092

(57) ABSTRACT

This data analysis device is provided with: a learning means that performs reinforcement learning in which a policy function is updated using an evaluation function that includes a value function, and the value function is updated using an evaluation function that includes the policy function; and an evaluation means that evaluates the degree of influence imposed by evaluation data on learning results using an evaluation of learning results obtained when the reinforcement learning is performed using a data set that includes the evaluation data, and an evaluation of learning results obtained when the reinforcement learning is performed using a data set that does not include the evaluation data.

### TECHNICAL FIELD

The present invention relates to a data analysis device, a display device, a data analysis method, and a recording medium.

### BACKGROUND ART

Reinforcement learning is one of machine learning (refer to, for example, Patent Literature 1).

### CITATION LIST

### Patent Literature

PTL 1: Japanese Unexamined Patent Application Publication No. 2021-033332

### SUMMARY OF INVENTION

### Technical Problem

It is preferable that a degree of influence of individual data used for reinforcement learning on a learning result can be evaluated.

An object of the present disclosure is to provide a data analysis device, a data analysis method, and a recording medium capable of solving the above-described problems.

### Solution to Problem

According to a first aspect of the present invention, a data analysis device includes a learning means for performing reinforcement learning of updating a policy function using an evaluation function including a value function and updating the value function using the evaluation function including the policy function, and an evaluation means for evaluating a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

According to a second aspect of the present invention, a display device includes a display means for displaying a degree of influence of data included in a training data set serving as a data set used for reinforcement learning on a result of the reinforcement learning.

According to a third aspect of the present invention, a data analysis method including performing, by a computer, reinforcement learning of updating a policy function using an evaluation function including a value function and updating the value function using the evaluation function including the policy function, and evaluating, by the computer, a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

According to a fourth aspect of the present invention, a program causes a computer to execute reinforcement learning of updating a policy function using an evaluation function including a value function and updating the value function using the evaluation function including the policy function, and evaluation on a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

### Advantageous Effects of Invention

According to the present invention, it is possible to evaluate a degree of influence of individual data used for reinforcement learning on a learning result.

### BRIEF DESCRIPTION OF DRAWINGS

FIG. 1 is a diagram illustrating an example of a configuration of a data analysis device according to an example embodiment.

FIG. 2 is a diagram illustrating an example of display of evaluation on a result of reinforcement learning by a display unit according to the example embodiment.

FIG. 3 is a diagram illustrating an example of a procedure in which the data analysis device according to the example embodiment evaluates a degree of influence of data on the result of reinforcement learning.

FIG. 4 is a diagram illustrating another example of the configuration of the data analysis device according to the example embodiment.

FIG. 5 is a diagram illustrating an example of a configuration of a display device according to the example embodiment.

FIG. 6 is a diagram illustrating an example of a configuration of a processing device according to the example embodiment.

FIG. 7 is a diagram illustrating an example of a procedure of processing in a data analysis method according to the example embodiment.

FIG. 8 is a schematic block diagram illustrating a configuration of a computer according to at least one example embodiment.

### EXAMPLE EMBODIMENT

Hereinafter, an example embodiment of the present invention will be described, but the following example embodiment does not limit the invention within the scope of the claims. In addition, not all combinations of features described in the example embodiment is essential to the solution of the invention.

Hereinafter, a character to which a macron or an overline is attached may be represented by adding⁻ after the character. For example, a character with a macron attached to “φ” is also referred to as “φ⁻”.

A character string with a macron or an overline may be represented by enclosing the character string in parentheses, followed by ⁻. For example, a character string in which an overline is added to “Mⱼ” is also written as “(Mⱼ)⁻”.

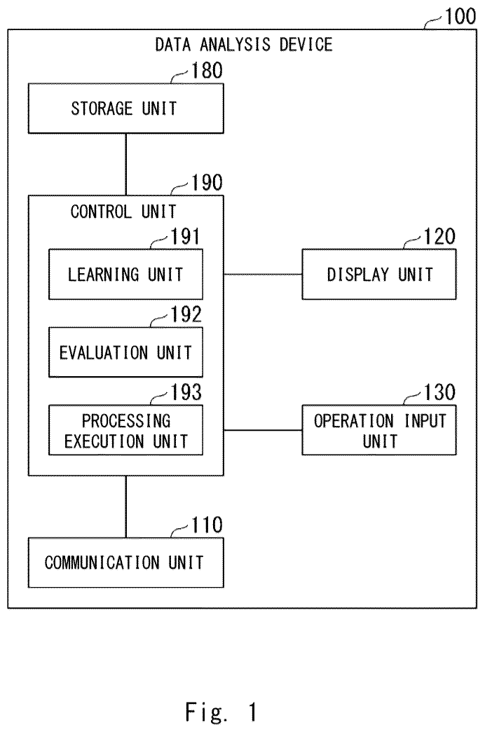

FIG. 1 is a diagram illustrating an example of a configuration of a data analysis device according to an example embodiment. In the configuration illustrated in FIG. 1, a data analysis device 100 includes a communication unit 110, a display unit 120, an operation input unit 130, a storage unit 180, and a control unit 190. The control unit 190 includes a learning unit 191, an evaluation unit 192, and a processing execution unit 193.

The data analysis device 100 evaluates how much individual data included in a data set used for reinforcement learning affects the reinforcement learning.

Specifically, the data analysis device 100 evaluates how much data to be evaluated affects a learning result by comparing evaluation on a learning result in the case of using the data set including the data to be evaluated with evaluation on a learning result in the case of using the data set not including the data to be evaluated.

The data set used for reinforcement learning is also referred to as a training data set. The data set used for evaluation on the learning result is also referred to as a test data set.

The reinforcement learning here is machine learning that learns a policy, which is an action rule of an agent that performs an action for a certain environment, based on a state in the environment and a reward representing evaluation for the state or the action.

The “agent” in the reinforcement learning targeted by the data analysis device 100 is not limited to a specific agent. For example, the “agent” may be a robot such as an autonomous mobile robot or an industrial robot, or may be a moving body such as an unmanned carrier or a drone. Alternatively, the “agent” may be a plant such as a factory or a power plant, or a part thereof, or may be a single device.

The “agent” is also referred to as a control target.

The evaluation result by the data analysis device 100 can be used, for example, for editing a training data set, analysis and adjustment of “agent” or “environment”, or the like.

For example, consideration is given as to a case in which the “agent” is a robot, and the performance of the robot obtained as a result of reinforcement learning varies depending on the period of time when data is obtained for the data included in the training data set. As a factor that the result of the reinforcement learning varies depending on the period of time when the data is obtained, a difference in environment, a difference in policy for collecting data, and the like can be considered.

Then, it is assumed that the data analysis device 100 evaluates that the performance of the robot based on the result of the reinforcement learning is relatively better in a case where the influence of new data is relatively strong than in a case where the influence of old data is relatively strong.

In this case, the data analysis device 100 may delete all or some old data from the training data set. Then, the data analysis device 100 may perform the reinforcement learning of the robot again using the training data set from which the old data has been deleted.

As a result, new data is easily reflected in the reinforcement learning, and it is expected that the performance of the robot based on the result of the reinforcement learning is improved.

In addition, in the data analysis device 100, by deleting the old data from the training data set, the data size of the training data set is reduced, and the storage capacity required for storing the training data set can be made relatively small. In addition, in terms of reducing the data size of the training data set, in a case where the data analysis device 100 performs the reinforcement learning of the robot using the training data set after the data reduction, it is expected that the time required for the learning becomes relatively short, for example, the learning result converges in a relatively short time.

Alternatively, in a case where the data analysis device 100 can select the same data from the training data set a plurality of times when performing the reinforcement learning of the robot again, the frequency of selecting each data from the training data set may be adjusted so that the frequency of selecting new data becomes relatively high.

As a result, new data is easily reflected in the reinforcement learning, and it is expected that the performance of the robot based on the result of the reinforcement learning is improved.

In addition, it is expected that the time required for learning becomes in relatively short, for example, the learning result converges in a relatively short time.

Furthermore, the data analysis device 100 may display the evaluation on the performance of the robot based on the result of the reinforcement learning in association with the data evaluated as having a strong influence on the learning result. For example, the user may adjust a robot or an operation environment of the robot with reference to data associated with the evaluation that the performance of the robot is good.

Furthermore, for example, in a case where data indicates that the performance of a robot is good when humidity in the room in which the robot operates is in the range of 40% to 60%, a user may adjust the humidity in the room to be in the range of 40% to 60% by using a humidifier, a dehumidifier, or the like.

Alternatively, the data analysis device 100 may automatically adjust a robot or the operation environment of the robot. For example, the data analysis device 100 may store therein in advance a rule indicating a relationship between humidity indicated by data associated with evaluation that the performance of a robot is good and settings for a humidifier and a dehumidifier, and may set the humidifier and the dehumidifier according to the rule.

The communication unit 110 communicates with other devices. For example, the communication unit 110 may receive a training data set from a server device that stores the training data set therein. Alternatively, in a case where the data analysis device 100 acquires the training data set using an actual machine to be controlled or a simulator outside the data analysis device 100, a command instructing “action” may be transmitted to the actual machine to be controlled or the simulator. Then, the data analysis device 100 may receive data indicating an observation result of the “environment” from a sensor device or the simulator.

For example, the display unit 120 includes a display screen such as a liquid crystal panel or a light emitting diode (LED) panel, and displays various images. For example, the display unit 120 may display an evaluation result of the influence of the data on a learning result.

The display unit 120 corresponds to an example of a display means.

The operation input unit 130 includes an input device such as a keyboard and a mouse, and receives a user operation. For example, the operation input unit 130 may receive a user operation of an issuing an instruction to delete a part of the data from the training data set.

The storage unit 180 stores various pieces of data. For example, the storage unit 180 may store therein a training data set, a test data set, and various parameters to be updated in the reinforcement learning. The storage unit 180 is configured using a storage device included in the data analysis device 100.

The control unit 190 controls each unit of the data analysis device 100 to perform various types of processing. The function of the control unit 190 may be executed by allowing a central processing unit (CPU) included in the data analysis device 100 to read a program from the storage unit 180 and to execute the program.

The learning unit 191 performs reinforcement learning using the training data set.

Hereinafter, a description will be given, as an example, as to a case in which a policy function and a value function are each configured using a neural network, and the learning unit 191 performs reinforcement learning using a mask that designates a partial network excluding a part of the neural network.

The value function mentioned here is a function that outputs a predicted value of the reward. More specifically, the value function is a function that outputs a predicted value of a cumulative sum of discounted rewards obtained thereafter when an agent takes a certain action in a certain state.

Hereinafter, a case in which a Q function is used as the value function will be described as an example. However, the value function used by the data analysis device 100 is not limited to a specific value function.

The mask used for reinforcement learning is also referred to as a learning mask.

As used herein, the fact that the function is configured using the neural network means that the neural network is used to calculate a value of the function. The 1 partial network excluding a part of the neural network may be a neural network configured by a partial network excluding one or more intermediate nodes from the neural network.

The learning unit 191 generates a unique learning mask for each data included in the training data set for each of the policy function and the Q function.

Regarding the policy function, configuring the partial network designated by the mask (temporarily) is also referred to as applying the mask to the policy function. Regarding the Q function, configuring the partial network designated by the mask (temporarily) is also referred to as applying the mask to the Q function.

In a case where a plurality of Q functions are used in reinforcement learning, the learning unit 191 may generate a unique learning mask for each data included in the training data set for each of the plurality of Q functions. Alternatively, in a case where a plurality of Q functions are configured using neural networks having the same structure, the learning unit 191 may generate a learning mask common to the plurality of Q functions uniquely for each data included in the training data set.

Every time data is sampled from the training data set, the learning unit 191 applies a learning mask associated with sampled data to the neural network and updates parameter values of the policy function and the Q function.

Here, the parameters of the policy function and the Q function are parameters of the neural network constituting the policy function and parameters of the neural network constituting the Q function. A parameter of a masked portion among the parameters of the neural network is excluded from an update target of the parameter value in the reinforcement learning for the data associated with the mask.

In the reinforcement learning using the mask, it can be grasped that the learning unit 191 performs the reinforcement learning on the masked portion of the neural network using a data set not including data associated with the learning mask. Furthermore, the learning unit 191 can be regarded as performing reinforcement learning on an unmasked portion of the neural network using a data set including the data associated with the learning mask.

As described above, the learning unit 191 performs the reinforcement learning using the learning mask, so that the reinforcement learning using the data set including the individual data included in the training data set and the reinforcement learning using the data set not including the individual data can be performed by one reinforcement learning. In this respect, the learning unit 191 can efficiently perform reinforcement learning for evaluating the influence of individual data on reinforcement learning.

However, a method in which the learning unit 191 performs reinforcement learning based on a data set including certain data and reinforcement learning based on a data set not including the data is not limited to a method using a learning mask. For example, the learning unit 191 may perform reinforcement learning using all data included in the training data set, and may perform reinforcement learning using all data other than the data for each data included in the training data set.

In addition, the machine learning model constituting each of the policy function and the Q function is not limited to the neural network. As a machine learning model constituting each of the policy function and the Q function, various models capable of executing calculation of a function value in a partial model can be used.

The learning unit 191 alternately repeats the update of a parameter value of the policy function and the update of a parameter value of the Q function by using the policy function including the Q function and the Q function including the policy function.

Hereinafter, a description will be given, as an example, as to a case in which the learning unit 191 updates values of parameters φ₁ and φ₂ of the Q function based on Equation (1).

$$[ Mathematical Formula 1 ]$$

$${arg min}_{{φ}_{i}} {E}_{( s , a , r , {s}^{′} , j ) ∼ D} [ {( r + γ ( {min}_{i ∈ 1 , 2} {Q}_{{\overline{φ}}_{i} , {M}_{j}} ( {s}^{′} , {a}^{′} ) - α log {π}_{θ , {M}_{j}} ( {a}^{′} \vert {s}^{′} ) ) - {Q}_{{φ}_{i} , {M}_{j}} ( s , a ) )}^{2} ] \qquad ( 1 )$$

In Equation (1), i=1 and 2, and the parameter values of the Q function are calculated in two ways such as the parameters φ₁ and φ₂.

“argumin” is a function that outputs a value of a variable indicated under “argumin” such that a value of a function indicated after “argumin” becomes minimized. Equation (1) indicates that a value of a parameter φᵢ is obtained such that a value of the function indicated after “argumin” becomes minimized.

E represents an expected value.

“(s, a, r, s′, j)~D” indicates that four sets of data (s, a, r, s′) of a state s, an action a, a reward r, and a next state s′ follow the distribution in a replay buffer D. “j” represents an identification number of the four sets of data (s, a, r, s′).

The four sets of data (s, a, r, s′) are also simply referred to as data.

The replay buffer D is a buffer for recording data used for reinforcement learning. A set of data recorded in the replay buffer D at the end of the reinforcement learning corresponds to an example of the training data set.

γ is a coefficient of a constant indicating a discount rate.

α is a coefficient of a constant indicating the step size.

“min” is a function that outputs the minimum value of an Equation shown after “min” under the condition shown under “min”.

“Q” indicates a Q function, and description below “Q” indicates a condition applied to the Q function. “Q_{φ}_{^{−}}_{i, Mj}(s′, a′)” indicates that a value of the Q function in a case where the action a′ is performed under the next state s′ is calculated by applying a target parameter φ⁻ᵢ as a parameter of the Q function and applying a learning mask Mⱼ to the Q function.

j represents an identification number of data. The identification number of the data can also be used as an identification number of a mask.

As described above, the Q function corresponds to an example of a value function. The value of the Q function is also referred to as a Q value.

The target parameter φ⁻ᵢ is a parameter used to avoid a sudden change in the Q value. The value of the target parameter φ⁻ᵢ is updated to a value obtained by taking a weighted average of the own value of the target parameter φ⁻ᵢ and the value of the parameter φᵢ of the Q function. The update of the value of the target parameter φ⁻ᵢ can be represented as Equation (2).

$$[ Mathematical Formula 2 ]$$

$${\overline{φ}}_{i} ← ρ {\overline{φ}}_{i} + ( 1 - ρ ) {φ}_{i} \qquad ( 2 )$$

ρ is a coefficient of a constant representing a weight for the value of the target parameter φ⁻ᵢ.

“π” indicates a policy function, and a description below “π” indicates a condition applied to the policy function. “θ, Mⱼ” of “π_{θ, Mj} (a′|s′)” indicates that a parameter θ is applied as a parameter of a policy function π and the learning mask Mⱼ is applied to the policy function π.

Here, a description will be given, as an example, as to a case in which the policy function π is configured as a conditional probability density function that stochastically selects an action depending on a state. “(a′|s′)” represents that the policy function π selects the action a′ under the state s′.

a′ represents an action determined for the next state s′ by the policy function π to which the learning mask Mⱼ is applied. The action a′ can be represented as Equation (3).

$$[ Mathematical Formula 3 ]$$

$${a}^{′} ∼ {π}_{θ , {M}_{j}} ( \cdot \vert {s}^{′} ) \qquad ( 3 )$$

“π_{θ, Mj} (a′|s′)” represents a probability that the policy function π selects the action a′ under the next state s′.

Equation (1) represents that the value of the parameter φᵢ is determined such that the magnitude of a difference obtained by subtracting an estimated value of the sum of future rewards calculated as a Q value from the sum of rewards when the action a is taken in the state s and an estimated value of the sum of future rewards expected when the action a′ is taken in the next state s′ becomes as small as possible.

In the following, a description will be given, as an example, as to a case in which the learning unit 191 updates the value of the parameter θ of the policy function based on Equation (4).

$$[ Mathematical Formula 4 ]$$

$${arg min}_{θ} {E}_{( s , j ) ∼ D} [ log {π}_{θ , {M}_{j}} ( a \vert s ) - {Q}_{{φ}_{i} , {M}_{j}} ( s , a ) ] \qquad ( 4 )$$

The term “log” in Equation (4) is a term representing a policy entropy. Equation (4) represents that the value of the parameter θ is determined such that the estimated value of the sum of future rewards calculated as the Q value becomes as large as possible and the randomness of the action indicated by the value of the policy entropy term becomes as large as possible.

However, the policy function and the value function used by the data analysis device 100 are not limited to specific ones. For example, the policy function used by the data analysis device 100 is not limited to one that stochastically selects an action, and may be one that deterministically selects an action depending on a state or the like.

In addition, a reinforcement learning method used by the data analysis device 100 can be various methods of alternately repeating the update of the parameter value of the policy function and the update of the parameter value of the value function.

Furthermore, a ratio between the masked portion and the unmasked portion in the learning mask is not limited to a specific ratio.

The evaluation unit 192 evaluates a degree of influence of individual data on learning. Specifically, the evaluation unit 192 evaluates a degree of influence of data to be evaluated on learning by using evaluation on a learning result when the learning unit 191 performs the reinforcement learning using a data set including the data to be evaluated and evaluation on a learning result when the learning unit 191 performs the reinforcement learning using a data set not including the data to be evaluated.

Hereinafter, a description will be given, as an example, as to a case in which the evaluation unit 192 evaluates a degree of influence of individual data on learning using a mask obtained by inverting a learning mask. The mask obtained by inverting the learning mask is also referred to as an inversion mask. The inversion mask of the learning mask Mⱼ is also denoted as (Mⱼ)⁻.

The mask inversion here is to invert a portion included in a partial network and a portion excluded from the partial network in the portion of the neural network. More specifically, among the intermediate nodes of the neural network, the intermediate node included in the partial network in the learning mask is excluded from the partial network in the inversion mask. Among the intermediate nodes of the neural network, the intermediate node excluded from the partial network by the learning mask is included in the partial network by the inversion mask.

The evaluation unit 192 generates the inversion mask (Mⱼ)⁻ for the learning mask Mⱼ associated with data dⱼ for the data dⱼ to be evaluated for the degree of influence.

The evaluation unit 192 generates the inversion mask (Mⱼ)⁻ for each learning mask. Therefore, the evaluation unit 192 generates the inversion mask (Mⱼ)⁻ for each of the policy function and the Q function.

In a case where a plurality of Q functions are used in reinforcement learning and the learning unit 191 generates the learning mask Mⱼ for each of the plurality of Q functions, the evaluation unit 192 generates the inversion mask (Mⱼ)⁻ for each of the plurality of Q functions. Alternatively, in a case where the learning unit 191 generates the learning mask Mⱼ common to the plurality of Q functions, the evaluation unit 192 generates the inversion mask (Mⱼ)⁻ common to the plurality of Q functions in advance.

In a case where there is a plurality of pieces of data dⱼ to be evaluated, the evaluation unit 192 generates the inversion mask (Mⱼ)⁻ for each piece of data dⱼ to be evaluated. For example, in a case where all the data dⱼ included in the replay buffer D are evaluation targets, the evaluation unit 192 generates the inversion mask (Mⱼ)⁻ of each of all the data dⱼ included in the replay buffer D.

Then, the evaluation unit 192 calculates a performance evaluation index of an agent by using data included in a test data set without applying a mask to either the policy function or the Q function. The evaluation unit 192 uses the performance evaluation index obtained in this case as an evaluation value of the result of the reinforcement learning using all the data included in the training data set.

As the performance evaluation index of the agent, an index having correlation with an expected value of rewards obtained under the test data set may be used.

Furthermore, the evaluation unit 192 applies the inversion mask (Mⱼ)⁻ corresponding to one piece of data dⱼ to be evaluated to each of the policy function and the Q function, and calculates the performance evaluation index of the agent using the data included in the test data set. The evaluation unit 192 uses the performance evaluation index obtained in this case as the evaluation value of the result of the reinforcement learning using the data obtained by excluding the data associated with the inversion mask from the data included in the training data set.

The evaluation unit 192 compares the evaluation value of the result of the reinforcement learning using all the data included in the training data set with the evaluation value of the result of the reinforcement learning using the data obtained by excluding the data associated with the inversion mask from the data included in the training data set, thereby evaluating the degree of influence of the data associated with the inversion mask on the result of the reinforcement learning.

For example, the evaluation unit 192 calculates, as the evaluation value of the degree of influence of the data associated with the inversion mask on the result of the reinforcement learning, a difference obtained by subtracting the evaluation value of the result of the reinforcement learning using all the data included in the training data set from the evaluation value of the result of the reinforcement learning using the data obtained by excluding the data associated with the inversion mask from the data included in the training data set.

The evaluation unit 192 calculates, for each piece of data to be evaluated, an evaluation value of the degree of influence of the data on the result of the reinforcement learning.

The evaluation unit 192 may calculate the evaluation value of the degree of influence of the data on the result of the reinforcement learning using Equation (5).

$$[ Mathematical Formula 5 ]$$

$$I = L ( {Q}_{{\overline{φ}}_{i} , \overline{{M}_{j}}} , {Q}_{{φ}_{i} , \overline{{M}_{j}}} , {π}_{θ , \overline{{M}_{j}}} {D}_{t e s t} ) - L ( {Q}_{{φ}_{i}} , {Q}_{{φ}_{i}} , {π}_{θ} , {D}_{t e s t} ) \qquad ( 5 )$$

I represents an evaluation index of the degree of influence of the data dⱼ on the result of the reinforcement learning.

L represents a performance evaluation index. The performance evaluation index mentioned herein is an index indicating evaluation on performance of an agent as a result of reinforcement learning.

In Equation (5), a difference obtained by subtracting a performance evaluation index in a case where the mask is not applied to the Q function and the policy function from a performance evaluation index in a case where the inversion mask (Mⱼ)⁻ is applied to the Q function and the policy function is used as the evaluation index of the degree of influence of the data dⱼ on the result of the reinforcement learning.

It can be grasped that the Q function and the policy function in a case where the inversion mask (Mⱼ)⁻ is applied are not affected by learning when the data dⱼ is used. From this, in Equation (5), it can be understood that a change in the performance evaluation index between a case in which a training data set excluding the data di is used and a case in which a training data set including the data dⱼ is used is evaluated as a degree of influence of the data dⱼ.

The evaluation unit 192 may use an index represented by Equation (6) as a performance evaluation index L.

$$[ Mathematical Formula 6 ]$$

$$L = \frac{{E}_{( s , a , r , {s}^{′} , j ) ∼ {D}_{test}} [ {Q}_{{φ}_{i} , \overline{{M}_{j}}} ( s , a ) - {Q}^{π} ( s , a ) ]}{\vert {E}_{( \overline{s} \overline{, a} ) ∼ {D}_{t e s t}} [ {Q}^{π} ( \overline{s} , \overline{a} ) ] \vert} \qquad ( 6 )$$

Q^{π} represents a discounted cumulative reward sum actually obtained in the future in a case of following the policy function π under a certain state and action. s⁻ represents a state sampled from a test data set Dₜₑₛₜ. a⁻ represents an action sampled from the test data set Dₜₑₛₜ.

A performance evaluation index L shown in Equation (6) indicates a degree of error of how much a value of the Q function deviates from a correct value. The closer the value of L is to 0, the better the performance of the Q function is, and the larger an absolute value of the value of L is, the worse the performance of the Q function is.

In a case where the learning unit 191 performs reinforcement learning using all data other than the data to be evaluated in the data included in the training data set as reinforcement learning using the data set not including the data to be evaluated, the evaluation unit 192 may calculate the performance evaluation index L using a Q value based on a result of reinforcement learning using all data other than the data to be evaluated among the pieces of data included in the training data set, instead of a Q value in a case of using the inversion mask (Mⱼ)⁻ indicated by “Q_{φi, (Mj)} _{^{−}}(s, a)” in Equation (6).

However, the method of calculating the performance evaluation index L in Equation (5) is not limited to a specific method.

In addition, the test data set Dₜₑₛₜ may be configured in the form of an episode. Then, the evaluation unit 192 may calculate the performance evaluation index L by using the total of the rewards obtained in one episode as a true value of the value in the episode.

Furthermore, the mask used by the evaluation unit 192 is not limited to the inversion mask. The evaluation unit 192 may invert a portion that is not masked by the learning mask so as to be masked, and may use an inverted mask so as not to mask only a part of a portion that is masked by the learning mask. That is, a part of the portion masked with the learning mask may also be masked by the mask used by the evaluation unit 192.

The mask used by the evaluation unit 192 is also referred to as an evaluation mask.

The test data set Dₜₑₛₜ is not limited to a specific data set, and can be various data sets that can operate the agent. The test data set Dₜₑₛₜ may be the same data set as the training data set, or may be a data set different from the training data set. The test data set and the training data set may not include common data.

The processing execution unit 193 executes processing based on the evaluation result by the evaluation unit 192. The processing execution unit 193 corresponds to an example of a processing execution means. The data analysis device 100 corresponds to an example of a processing device.

Based on the evaluation result by the evaluation unit 192, the processing execution unit 193 may delete, from among the data included in the training data set, data that is determined to have a stronger influence than a predetermined standard when the performance of the agent is worse than a predetermined standard.

For example, as described above for the data analysis device 100, in a case where it is determined that the performance of a robot based on the result of the reinforcement learning is relatively better in a case where the influence of new data is relatively strong than in a case where the influence of old data is relatively strong, the processing execution unit 193 may delete all or some of the old data from the training data set.

The processing execution unit 193 may automatically delete data or may delete data in accordance with a user's instruction.

When the learning unit 191 performs the reinforcement learning again, the processing execution unit 193 may adjust the frequency at which each data included in the training data set is selected based on the evaluation result by the evaluation unit 192.

For example, as described above for the data analysis device 100, the processing execution unit 193 may adjust the frequency of selecting each data included in the training data set such that the frequency of selecting new data becomes relatively high when the learning unit 191 performs reinforcement learning of the robot again.

The processing execution unit 193 may adjust a control target or an operation environment of the control target based on the evaluation result by the evaluation unit 192. The control target here corresponds to an agent in reinforcement learning. The operation environment of the control target corresponds to an environment in reinforcement learning.

For example, as described above for the data analysis device 100, the storage unit 180 may store in advance a rule indicating a relationship between humidity indicated in data associated with evaluation indicating that the performance of a robot is good and settings for a humidifier and a dehumidifier. Then, the processing execution unit 193 may set the humidifier and the dehumidifier according to the rule so that the humidity is set such that the performance of the robot is good in the evaluation by the evaluation unit 192.

The processing execution unit 193 may automatically adjust a control target or an operation environment of the control target, or may perform adjustment in accordance with a user's instruction.

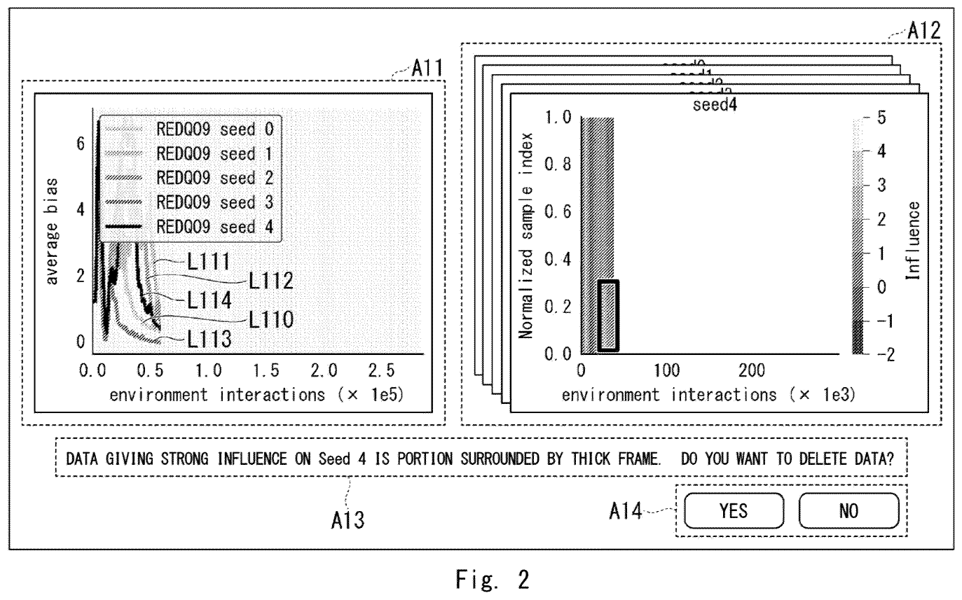

FIG. 2 is a diagram illustrating an example of display of evaluation on a result of reinforcement learning by the display unit 120.

FIG. 2 illustrates an example of a display screen of evaluation on a result of reinforcement learning for five quadruped walking robots. The five robots are named REDQ09 seed0, REDQ09 seed1, REDQ09 seed2, REDQ09 seed3, REDQ09 seed4, and REDQ09 seed5.

The display unit 120 displays a display screen of evaluation on a result of reinforcement learning under the control of the control unit 190. For example, the display unit 120 may display a display screen of evaluation on a result of reinforcement learning under the control of the evaluation unit 192 and/or the processing execution unit 193.

An area A11 is an area in which a graph indicating performance evaluation for each robot operated a certain number of times is displayed.

The horizontal axis of the graph of the area A11 indicates the number of times of interaction between a robot and an environment (that is, the number of times of action selection according to a policy) in 10⁵ units. In the example of FIG. 2, in the reinforcement learning by the learning unit 191, every time the interaction between the robot and the environment is repeated 10³ times, the evaluation unit 192 performs a motion test and records the evaluation value in the storage unit 180. The vertical axis indicates an evaluation value of the performance of the robot. The closer an average bias of the evaluation is to 0, the better the evaluation is. In the example of FIG. 2, the larger a degree of forward movement of the robot per unit time, the better the evaluation, and the average bias of the evaluation becomes close to 0.

A line L110 indicates an average bias of the evaluation for each repetition of the operation of the REDQ09 seed0. A line L111 indicates an average bias of the evaluation for each repetition of the operation of the REDQ09 seed1. A line L112 indicates an average bias of the evaluation for each repetition of the operation of the REDQ09 seed2. A line L113 indicates an average bias of the evaluation for each repetition of the operation of the REDQ09 seed3. A line L114 indicates an average bias of the evaluation for each repetition of the operation of the REDQ09 seed4.

An area A12 is an area in which a graph showing, for each robot, a degree of influence of data used for the reinforcement learning of the robot on the result of the reinforcement learning is displayed as a heat map. The display unit 120 displays a graph related to each robot in each window from the seed0 to the seed4.

The horizontal axis of the graph of the area A12 indicates the number of times of execution of a motion test of the robot in units of 10³. The vertical axis indicates a value in which the number of data is normalized within a range of 0 to 1. For example, the evaluation unit 192 assigns serial number identification numbers to each data included in the test data set in chronological order of the data, and performs normalization. The closer the value of a normalized sample index on the vertical axis is to 0, the older the data is, and the closer the value is to 1, the newer the data is.

The heat map illustrated in the area A12 indicates the degree of influence of the data in the motion test for each number of times of execution of the motion test of the robot indicated by the horizontal axis of the graph and for each data indicated by the number on the vertical axis of the graph. The stronger the influence of the data, the larger the value of Influence, and the thinner the hatching in the heat map.

An area A13 is an area in which a message from the data analysis device 100 to a user is displayed.

Here, in the graph of the area A11, the average bias of the REDQ09 seed4 indicated by the line L114 is away from 0. The user determines that the performance of the REDQ09 seed4 is bad with reference to the graph of the area A11, and selects the graph of the REDQ09 seed4 among the graphs of the respective robots illustrated in the area A12. The display unit 120 displays the window of the graph of the selected REDQ09 seed4 among the windows for each graph on the forefront.

Then, the display unit 120 displays a message related to the graph of the selected REDQ09 seed4 in the area A13. In the example of FIG. 2, the processing execution unit 193 determines that data corresponding to a portion surrounded by a thick frame in the graph of the REDQ09 seed4 gives a strong evaluation on the performance of the REDQ09 seed4 based on the evaluation by the evaluation unit 192. Then, the processing execution unit 193 causes the display unit 120 to display a message of an inquiry as to whether to delete the data corresponding to the portion surrounded by the thick frame.

An area A14 is a display area of a button for receiving a user operation. The display unit 120 displays a “YES” button and a “NO” button in the area A14. The operation input unit 130 receives, for example, a user operation of selecting either the “YES” button or the “NO” button by mouse click or screen touch.

In a case where the operation input unit 130 detects a user operation of selecting the “YES” button, the processing execution unit 193 deletes the data corresponding to the portion surrounded by the thick frame in the graph of the EDQ09 seed4 from the training data set.

On the other hand, in a case where the operation input unit 130 detects a user operation of selecting the “NO” button, the processing execution unit 193 does not delete data. In this case, the display unit 120 may eliminate the display of the message in the area A13 and the display of the button in the area A14.

FIG. 3 is a diagram illustrating an example of a procedure in which the data analysis device 100 evaluates a degree of influence of data on a result of reinforcement learning.

### (Step S1)

The learning unit 191 performs initial setting of reinforcement learning.

Specifically, the learning unit 191 initializes a value of the parameter θ of the policy function and values of the parameters φ₁ and φ₂ of the Q function, and prepares the empty replay buffer D.

Furthermore, the learning unit 191 substitutes the value of the parameter φᵢ of the Q function for the target parameter φ⁻ᵢ. Here, i=1 and 2.

After step S1, the processing proceeds to step S2.

### (Step S2)

The learning unit 191 acquires data and adds the data to the replay buffer D.

Specifically, the learning unit 191 determines an action aₜ based on a policy function π_{θ} and a current state sₜ, and causes an agent to execute the determined action aₜ. Here, the time is represented by a time step, the current time is represented by “t”, and the next time is represented by “t+1”.

As a method of causing the agent to execute the action, it may be possible to simulate that the agent performs the action, or it may be possible to control an actual machine of a control target corresponding to the agent and cause the agent to perform the action.

Determining the action aₜ based on the policy function π_{θ} and the current state sₜ can be represented as Equation (7).

$$[ Mathematical Formula 7 ]$$

$${a}_{t} ∼ {π}_{θ} ( \cdot \vert {s}_{t} ) \qquad ( 7 )$$

Then, the learning unit 191 observes the obtained reward rₜ and the next state sₜ₊₁ and adds four sets of data (sₜ, aₜ, rₜ, sₜ₊₁) to the replay buffer D. Adding the four sets of data (sₜ, aₜ, rₜ, sₜ₊₁) to the replay buffer D can be represented as Equation (8).

$$[ Mathematical Formula 8 ]$$

$$D ← D ⋃ ( {S}_{t} {a}_{t} , {r}_{t} , {s}_{t + 1} ) \qquad ( 8 )$$

After step S2, the processing proceeds to step S3.

### (Step S3)

The learning unit 191 samples a mini-batch B from the replay buffer D.

Here, the mini-batch B is a set of four sets of data. The mini-batch B can be represented as Equation (9).

$$[ Mathematical Formula 9 ]$$

$$B = \{ {d}_{j} = ( s , a , r , {s}^{′} ) \} \qquad ( 9 )$$

dⱼ represents four sets of data. “j” of dⱼ represents an identification number for identifying four sets of data.

As described above, s represents a state. a represents an action. r represents a reward. s′ represents a next state of the state s. The four sets of data dⱼ are also simply referred to as data dⱼ.

Furthermore, the learning unit 191 generates the learning mask Mⱼ for each piece of data dⱼ.

After step S3, the processing proceeds to step S4.

### (Step S4)

The learning unit 191 calculates a Q target y. The Q target y is a value to be a target value of the Q function.

The learning unit 191 may calculate the Q target y based on Equation (10).

$$[ Mathematical Formula 10 ]$$

$$y = r + γ ( {min}_{i ∈ 1 , 2} {Q}_{{\overline{φ}}_{i} , {M}_{j}} ( {s}^{′} , {a}^{′} ) - α log {π}_{θ , {M}_{j}} ( {a}^{′} \vert {s}^{′} ) ) \qquad ( 10 )$$

As described above, Mⱼ represents the learning mask associated with the data dⱼ.

Q_{φ}_{^{−}}_{i,Mj} represents that the target parameter φ⁻ᵢ and the learning mask Mⱼ are applied to the Q function.

π_{θ,Mj} represents that the parameter θ and the learning mask Mⱼ are applied to the policy function.

The action a′ is determined based on the policy function π_{θ,Mj} to which the learning mask Mⱼ is applied and the next state s′.

After step S4, the processing proceeds to step S5.

### (Step S5)

The learning unit 191 updates the values of the parameters φ₁ and φ₂ of the Q function. The learning unit 191 updates the values of the parameters φ₁ and φ₂ based on the above Equation (1).

The learning unit 191 may update the values of the parameters φ₁ and φ₂ using a gradient descent method based on a gradient represented by Equation (11).

$$[ Mathematical Formula 11 ]$$

$${∇}_{φ} \frac{1}{\vert B \vert} {\sum }_{( s , a , r , {s}^{′} ) ∈ B} {( {Q}_{{φ}_{i} , {M}_{j}} ( s , a ) - y )}^{2} \qquad ( 11 )$$

|B| represents the size of the mini-batch B. Specifically, |B| represents the number of data dⱼ included in the mini-batch B.

After step S5, the processing proceeds to step S6.

### (Step S6)

The learning unit 191 updates the value of the target parameter φ⁻ᵢ. The learning unit 191 updates the value of the target parameter φ⁻ᵢ based on the above Equation (2).

After step S6, the processing proceeds to step S7.

### (Step S7)

The learning unit 191 updates the value of the parameter θ of the policy function. The learning unit 191 updates the value of the parameter θ based on the above Equation (4).

The learning unit 191 may update the value of the parameter θ using a gradient descent method based on a gradient represented by Equation (12).

$$[ Mathematical Formula 12 ]$$

$${∇}_{φ} \frac{1}{\vert B \vert} {\sum }_{s ∈ B} ( \frac{1}{N} {\sum }_{i = 1}^{N} {Q}_{{φ}_{i} , {M}_{j}} ( s , a ) - α log {π}_{θ , {M}_{j}} ( a \vert s ) ) \qquad ( 12 )$$

After step S7, the processing proceeds to step S8.

### (Step S8)

The learning unit 191 determines whether an end condition of the reinforcement learning is satisfied.

The end condition of the reinforcement learning here is not limited to a specific condition. For example, the end condition of the reinforcement learning here may be a condition that a loop from steps S2 to S8 is executed a predetermined number of times or more. Alternatively, the end condition of the reinforcement learning here may be a condition that the expected value shown in Equation (1) and the expected value shown in Equation (4), or any one of the expected values may be smaller than a predetermined value.

When the learning unit 191 determines that the end condition of the reinforcement learning is not satisfied (step S8: NO), the processing returns to step S2.

On the other hand, when the learning unit 191 determines that the end condition of the reinforcement learning is satisfied (step S8: YES), the processing proceeds to step S11.

### (Step S11)

The evaluation unit 192 acquires a test data set.

After step S11, the processing proceeds to step S12.

### (Step S12)

The evaluation unit 192 evaluates a degree of influence of data on a result of reinforcement learning.

The evaluation unit 192 may calculate an evaluation value of the degree of influence of the data dⱼ based on the above Equation (5).

After step S12, the processing proceeds to step S13.

### (Step S13)

The evaluation unit 192 determines whether the end condition of the evaluation on the degree of influence of the data on the result of the reinforcement learning is satisfied. As the end condition here, for example, a condition that the evaluation value of the degree of influence of all the data to be evaluated is calculated can be used.

When the evaluation unit 192 determines that the end condition of the evaluation on the degree of influence of the data on the result of the reinforcement learning is not satisfied (step S13: NO), the processing returns to step S12.

On the other hand, when the evaluation unit 192 determines that the end condition of the evaluation on the degree of influence of the data on the result of the reinforcement learning is satisfied (step S13: YES), the data analysis device 100 ends the processing in FIG. 3.

As described above, the learning unit 191 performs reinforcement learning of updating the policy function using the evaluation function including the value function, and updating the value function using the evaluation function including the policy function. The evaluation unit 192 evaluates the degree of influence of the data to be evaluated on the learning result by using the evaluation on the learning result in a case where the reinforcement learning is performed using the data set including the data to be evaluated and the evaluation on the learning result in a case where the reinforcement learning is performed using the data set not including the data to be evaluated.

With the data analysis device 100, it is possible to evaluate a degree of influence of individual data used for reinforcement learning on a learning result.

Furthermore, the learning unit 191 acquires any one piece of the data included in a training data set and selects a learning mask according to the acquired data. Then, in a state in which a selected learning mask is applied to a machine learning model constituting a policy and a machine learning model constituting a value function, the learning unit 191 updates a value of a parameter of a partial model of the machine learning model constituting the policy function and a value of a parameter of a partial model of the machine learning model constituting the value function using the acquired data.

The training data set is a data set used for reinforcement learning. The learning mask is a mask that uniquely designates a partial model excluding a part of the machine learning model constituting the policy function and a partial model excluding a part of the machine learning model constituting the value function for each data included in the training data set.

The evaluation unit 192 uses an evaluation value obtained by evaluating the learning result of the reinforcement learning in a state in which the evaluation mask is applied to the machine learning model constituting the policy and the machine learning model constituting the value function as the evaluation value of the learning result in a case where the reinforcement learning is performed using the data set not including the data to be evaluated, and evaluates the degree of influence of the data to be evaluated on the learning result.

The evaluation mask is a mask configured in such a manner that a portion subjected to exclusion in the learning mask corresponding to one piece of data to be evaluated selected from the data included in the training data set is not subjected to exclusion, and all or a part of the portion not subjected to exclusion in the learning mask is subjected to exclusion.

Here, consideration will be given as to a case in which the data to be evaluated is removed one by one from the training data set and reinforcement learning is performed, and the degree of influence of the data is evaluated. In this case, it is necessary to initialize each model of the policy function and the Q function for each data to be evaluated and perform reinforcement learning for each data.

On the other hand, in the data analysis device 100, by configuring a unique partial model for each data to be evaluated using a mask, learning regarding each data can be continuously performed without the need to initialize the model. With the data analysis device 100, in this respect, it is possible to efficiently perform the reinforcement learning for evaluating the influence of individual data on the reinforcement learning.

Furthermore, according to the data analysis device 100, by performing reinforcement learning using the learning mask, for individual data included in the training data set, reinforcement learning using a data set including the data and reinforcement learning using a data set not including the data can be performed by reinforcement learning one time. According to the data analysis device 100, also in this respect, it is possible to efficiently perform the reinforcement learning for evaluating the influence of individual data on the reinforcement learning.

Furthermore, the display unit 120 displays the degree of influence of the data included in the training data set on the result of the reinforcement learning.

The user can delete data from the training data set, adjust the selection frequency of data at the time of relearning, adjust the control target or the operation environment of the control target, or perform a combination thereof, as described above, with reference to the display of the display unit 120.

For example, the user refers to the display of the degree of influence of the data included in the training data set on the result of the reinforcement learning and the evaluation on the result of the reinforcement learning, and in a case where the evaluation on the result of the reinforcement learning is bad, the user can delete data having a strong degree of influence on the result of the reinforcement learning among the data included in the training data set.

As a result, in a case where the learning unit 191 performs the reinforcement learning again using the updated training data set, new data is easily reflected in the reinforcement learning, and it is expected that the result of the reinforcement learning is improved.

In addition, a part of data is deleted from the training data set, thereby making it possible not only to reduce the data size of the training data set, but also to make a storage capacity required for storage of the training data set relatively small. Furthermore, in terms of reduction in the data size of the training data set, in a case where the learning unit 191 performs reinforcement learning using the training data set obtained after data reduction, it is expected that the time required for learning becomes relatively short, for example, the learning result converges in a relatively short time.

Furthermore, in a case where the evaluation on the result of the reinforcement learning is bad, the user can change the setting of data selection at the time of the reinforcement learning so that the frequency of selecting data having a strong degree of influence on the result of the reinforcement learning among the data included in the training data set is reduced when the learning unit 191 performs the reinforcement learning again.

As a result, data considered to have a bad influence on the result of the reinforcement learning is less likely to be reflected in the reinforcement learning, and it is expected that the performance of the control target based on the result of the reinforcement learning is improved.

In addition, it is expected that the time required for learning becomes relatively short, for example, the learning result converges in a relatively short time.

Furthermore, the user can refer to data having a strong degree of influence on the result of the reinforcement learning when the result of the reinforcement learning is good, and can adjust the setting of the control target or the setting for the operation environment of the control target so as to reproduce a “state” when the result of the reinforcement learning is good.

Furthermore, the display unit 120 displays the degree of influence of the data included in the training data set on the result of the reinforcement learning and the evaluation on the result of the reinforcement learning.

The user can delete data from the training data set, adjust the selection frequency of data at the time of relearning, adjust the control target or the operation environment of the control target, or perform a combination thereof, as described above, with reference to the display of the display unit 120.

For example, the user refers to the display of the degree of influence of the data included in the training data set on the result of the reinforcement learning and the evaluation on the result of the reinforcement learning, and in a case where the evaluation on the result of the reinforcement learning is bad, the user can delete data having a strong degree of influence on the result of the reinforcement learning among the data included in the training data set.

As a result, in a case where the learning unit 191 performs the reinforcement learning again using the updated training data set, new data is easily reflected in the reinforcement learning, and it is expected that the result of the reinforcement learning is improved.

In addition, a part of data is deleted from the training data set, thereby making it possible not only to reduce the data size of the training data set, but also to make a storage capacity required for storage of the training data set relatively small. Furthermore, in terms of reduction in the data size of the training data set, in a case where the learning unit 191 performs reinforcement learning using the training data set obtained after data reduction, it is expected that the time required for learning becomes relatively short, for example, the learning result converges in a relatively short time.

Furthermore, in a case where the evaluation on the result of the reinforcement learning is bad, the user can change the setting of data selection at the time of the reinforcement learning so that the frequency of selecting data having a strong degree of influence on the result of the reinforcement learning among the data included in the training data set is reduced when the learning unit 191 performs the reinforcement learning again.

As a result, data considered to have a bad influence on the result of the reinforcement learning is less likely to be reflected in the reinforcement learning, and it is expected that the performance of the control target based on the result of the reinforcement learning is improved.

In addition, it is expected that the time required for learning becomes relatively short, for example, the learning result converges in a relatively short time.

Furthermore, the user can refer to data having a strong degree of influence on the result of the reinforcement learning when the result of the reinforcement learning is good, and can adjust the setting of the control target or the setting for the operation environment of the control target so as to reproduce a “state” when the result of the reinforcement learning is good.

Furthermore, the display unit 120 displays a degree of influence of the data included in the training data set on the result of the reinforcement learning, evaluation on the result of the reinforcement learning, and a message regarding deletion of a part of the data from among the data included in the training data set.

The user can determine whether to delete a part of the data included in the training data set with reference to the display of the display unit 120.

Furthermore, the display unit 120 displays, for each of the plurality of control targets, the evaluation for the result of the reinforcement learning for the control target, and displays, for each control target, the degree of influence of the data included in the training data set on the result of the reinforcement learning in a selectable manner. Then, the display unit 120 displays an inquiry as to whether to delete a part of the data selected based on the degree of influence on the result of the reinforcement learning for the selected control target among the data included in the training data set.

The user can select any one of the plurality of control targets with reference to the evaluation on the result of the reinforcement learning for each of the plurality of control targets, and can refer to the degree of influence of the data included in the training data set on the result of the reinforcement learning for the selected control target. Then, the user can determine whether to delete a part of the data indicated by the inquiry displayed on the display unit based on the referred degree of influence of the data included in the training data set on the result of the reinforcement learning.

In addition, the display unit 120 displays, in the form of a heat map, the degree of influence on the result of the reinforcement learning for each data and for each repetition of evaluation in a coordinate space constituted by a first axis indicating a numerical value for identifying data included in the training data set and a second axis indicating the number of times of repetition of evaluation on the degree of influence on the result of the reinforcement learning of each data included in the training data set.

The user can delete data from the training data set, adjust the selection frequency of data at the time of relearning, adjust the control target or the operation environment of the control target, or perform a combination thereof, as described above, with reference to the display of the display unit 120.

For example, the user refers to the display of the degree of influence of the data included in the training data set on the result of the reinforcement learning and the evaluation on the result of the reinforcement learning, and in a case where the evaluation on the result of the reinforcement learning is bad, the user can delete data having a strong degree of influence on the result of the reinforcement learning among the data included in the training data set.

As a result, in a case where the learning unit 191 performs the reinforcement learning again using the updated training data set, new data is easily reflected in the reinforcement learning, and it is expected that the result of the reinforcement learning is improved.

In addition, a part of data is deleted from the training data set, thereby making it possible not only to reduce the data size of the training data set, but also to make a storage capacity required for storage of the training data set relatively small. Furthermore, in terms of reduction in the data size of the training data set, in a case where the learning unit 191 performs reinforcement learning using the training data set obtained after data reduction, it is expected that the time required for learning becomes relatively short, for example, the learning result converges in a relatively short time.

Furthermore, in a case where the evaluation on the result of the reinforcement learning is bad, the user can change the setting of data selection at the time of the reinforcement learning so that the frequency of selecting data having a strong degree of influence on the result of the reinforcement learning among the data included in the training data set is reduced when the learning unit 191 performs the reinforcement learning again.

As a result, data considered to have a bad influence on the result of the reinforcement learning is less likely to be reflected in the reinforcement learning, and it is expected that the performance of the control target based on the result of the reinforcement learning is improved.

In addition, it is expected that the time required for learning becomes relatively short, for example, the learning result converges in a relatively short time.

Furthermore, the display unit 120 displays a heat map indicating the degree of influence on the result of the reinforcement learning for each piece of data and for each repetition of evaluation in a coordinate space constituted by a first axis indicating a numerical value for identifying data included in the training data set and a second axis indicating the number of times of repetition of evaluation on the degree of influence on the result of the reinforcement learning of each piece of data included in the training data set by including display of a portion selected according to the degree of influence in the heat map. In addition, the display unit 120 displays an inquiry as to whether to delete the data of the selected portion from the training data set.

The user can determine and instruct whether to delete the data of the selected portion from the training data set with reference to the display of the display unit 120. For example, in a case where the evaluation on the result of the reinforcement learning is bad and data having a strong degree of influence on the result of the reinforcement learning is selected, the user may delete the data of the selected portion from the training data set.

Furthermore, the display unit 120 displays, for each of the plurality of control targets, an evaluation for the result of the reinforcement learning in each repetition of the evaluation on the degree of influence on the result of the reinforcement learning of each data included in the training data set. In addition, the display unit 120 selectively displays, for each control target, a heat map indicating the degree of influence on the result of the reinforcement learning for each piece of data and for each repetition of evaluation in a coordinate space constituted by a first axis indicating a numerical value for identifying data included in the training data set and a second axis indicating the number of times of repetition of evaluation on the degree of influence by including display of a portion selected according to the degree of influence in the heat map. In addition, the display unit 120 displays an inquiry as to whether to delete the data of the selected portion in the selected heat map from the training data set.

The user can determine and instruct whether to delete the data of the selected portion from the training data set with reference to the display of the display unit 120. For example, in a case where the evaluation on the result of the reinforcement learning is bad and data having a strong degree of influence on the result of the reinforcement learning is selected, the user may delete the data of the selected portion from the training data set.

Further, the learning unit 191 performs reinforcement learning of updating the policy function using the evaluation function including the value function and updating the value function using the evaluation function including the policy function. The evaluation unit 192 evaluates the degree of influence of the data to be evaluated on the learning result by using the evaluation on the learning result in a case where the reinforcement learning is performed using the data set including the data to be evaluated and the evaluation on the learning result in a case where the reinforcement learning is performed using the data set not including the data to be evaluated. The processing execution unit 193 selects a part of the data among the data included in the training data set based on the evaluation on the learning result and the evaluation on the degree of influence, and deletes the selected data from the training data set.

In a case where the evaluation on the result of the reinforcement learning is bad, the data analysis device 100 can delete data having a strong degree of influence on the result of the reinforcement learning.

As a result, in a case where the learning unit 191 performs the reinforcement learning again using the updated training data set, new data is easily reflected in the reinforcement learning, and it is expected that the result of the reinforcement learning is improved.

In addition, a part of data is deleted from the training data set, thereby making it possible not only to reduce the data size of the training data set, but also to make a storage capacity required for storage of the training data set relatively small. Furthermore, in terms of reduction in the data size of the training data set, in a case where the learning unit 191 performs reinforcement learning using the training data set obtained after data reduction, it is expected that the time required for learning becomes relatively short, for example, the learning result converges in a relatively short time.

Further, the learning unit 191 performs reinforcement learning of updating the policy function using the evaluation function including the value function and updating the value function using the evaluation function including the policy function. The evaluation unit 192 evaluates the degree of influence of the data to be evaluated on the learning result by using the evaluation on the learning result in a case where the reinforcement learning is performed using the data set including the data to be evaluated and the evaluation on the learning result in a case where the reinforcement learning is performed using the data set not including the data to be evaluated. The processing execution unit 193 selects one or more data among the data included in the training data set based on the evaluation on the learning result and the evaluation on the degree of influence. Then, based on the selected data, the processing execution unit 193 performs adjustment on at least one of a control target, which is a target of reinforcement learning, and an operation environment of the control target.

As a result, the data analysis device 100 can automatically adjust at least one of the control target and the operation environment of the control target. For example, the data analysis device 100 can refer to data having a strong degree of influence on the result of the reinforcement learning in a case where the result of the reinforcement learning is good, and can adjust the setting of the control target or the setting for the operation environment of the control target so as to reproduce the “state” in a case where the result of the reinforcement learning is good.

The unit of data for which the evaluation unit 192 evaluates the influence of data is not limited to the unit of four sets of data.

For example, the training data sets may be configured in the form of episodes. Then, the learning unit 191 may generate a learning mask for each episode and perform reinforcement learning, and the evaluation unit 192 may evaluate, for each episode, the degree of influence of the episode on the result of the reinforcement learning.

In this case, the processing execution unit 193 may manage the training data set in units of episodes, such as deleting an episode from the training data set.

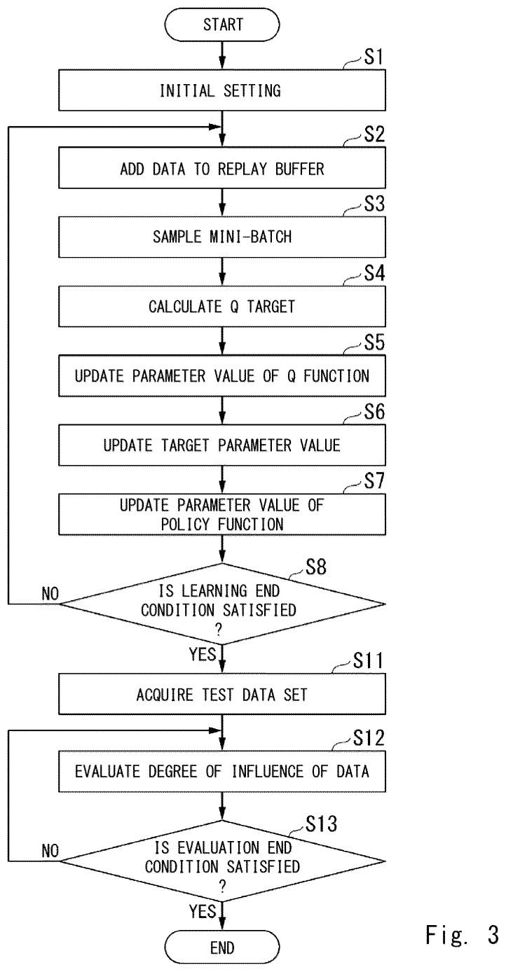

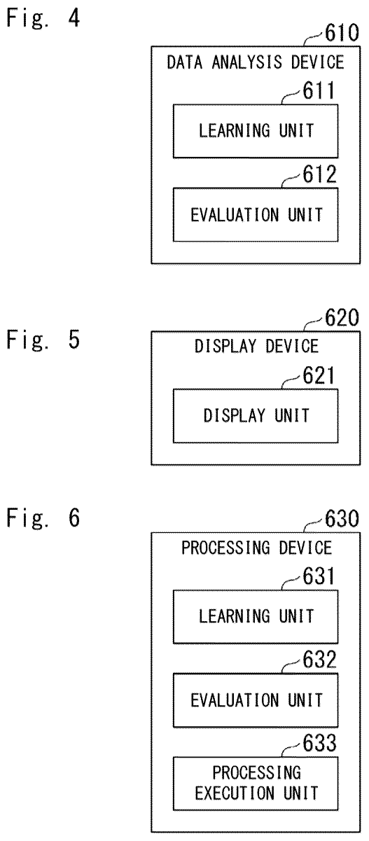

FIG. 4 is a diagram illustrating another example of the configuration of the data analysis device according to the example embodiment. In the configuration illustrated in FIG. 4, a data analysis device 610 includes a learning unit 611 and an evaluation unit 612.

With such a configuration, the learning unit 611 updates a policy function using an evaluation function including the value function, and updates a value function using the evaluation function including the policy function. The evaluation unit 612 evaluates a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

The learning unit 611 corresponds to an example of a learning means. The evaluation unit 612 corresponds to an example of an evaluation means.

According to the data analysis device 610, it is possible to evaluate a degree of influence of individual data used for reinforcement learning on a learning result.

The learning unit 611 can be implemented by using, for example, a function of the learning unit 191 or the like illustrated in FIG. 1. The evaluation unit 612 can be implemented by using, for example, a function of the evaluation unit 192 and the like illustrated in FIG. 1.

FIG. 5 is a diagram illustrating an example of a configuration of the display device according to the example embodiment. In the configuration illustrated in FIG. 5, a display device 620 includes a display unit 621.

With such a configuration, the display unit 621 includes a display unit that displays a degree of influence of data included in a training data set, which is a data set used for reinforcement learning, on a result of the reinforcement learning.

The display unit 621 corresponds to an example of a display means.

With the display device 620, the user can delete data from the training data set, adjust the selection frequency of data at the time of relearning, adjust the control target or the operation environment of the control target, or perform a combination thereof with reference to the display of the display unit 621.

For example, a user refers to the display of the degree of influence of the data included in the training data set on the result of the reinforcement learning and the evaluation on the result of the reinforcement learning, and in a case where the evaluation on the result of the reinforcement learning is bad, the user can delete data having a strong degree of influence on the result of the reinforcement learning among the data included in the training data set.

As a result, in a case where a device that performs reinforcement learning performs reinforcement learning again using the updated training data set, new data is easily reflected in the reinforcement learning, and it is expected that the result of the reinforcement learning is improved.

In addition, a part of data is deleted from the training data set, thereby making it possible not only to reduce the data size of the training data set, but also to make a storage capacity required for storage of the training data set relatively small. Furthermore, in terms of reduction in the data size of the training data set, in a case where the device that performs reinforcement learning performs reinforcement learning using the training data set after data reduction, it is expected that the time required for learning becomes relatively short, for example, the learning result converges in a relatively short time.

Furthermore, in a case where the evaluation on the result of the reinforcement learning is bad, the user can change the setting of data selection at the time of the reinforcement learning so that the frequency of selecting data having a strong degree of influence on the result of the reinforcement learning among the data included in the training data set is reduced when the device that performs the reinforcement learning performs the reinforcement learning again.

As a result, data considered to have a bad influence on the result of the reinforcement learning is less likely to be reflected in the reinforcement learning, and it is expected that the performance of the control target based on the result of the reinforcement learning is improved.

In addition, it is expected that the time required for learning becomes relatively short, for example, the learning result converges in a relatively short time.

Furthermore, the user can refer to data having a strong degree of influence on the result of the reinforcement learning when the result of the reinforcement learning is good, and can adjust the setting of the control target or the setting for the operation environment of the control target so as to reproduce a “state” when the result of the reinforcement learning is good.

The display unit 621 can be implemented by using, for example, a function of the display unit 120 or the like illustrated in FIG. 1.

FIG. 6 is a diagram illustrating an example of a configuration of a processing device according to the example embodiment. In the configuration illustrated in FIG. 6, a processing device 630 includes a learning unit 631, an evaluation unit 632, and a processing execution unit 633.

With such a configuration, the learning unit 631 performs reinforcement learning of updating a policy function using an evaluation function including the value function and updating a value function using the evaluation function including the policy function.

The evaluation unit 632 evaluates a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

The processing execution unit 633 selects a part of the data among the data included in the training data set, which is the data set used for the reinforcement learning, based on the evaluation on the learning result and the evaluation on the degree of influence, and deletes the selected data from the training data set.

The learning unit 631 corresponds to an example of a learning means. The evaluation unit 632 corresponds to an example of an evaluation means. The processing execution unit 633 corresponds to an example of a processing execution means.

In a case where the evaluation on the result of the reinforcement learning is bad, the processing execution unit 633 can delete data having a strong degree of influence on the result of the reinforcement learning.

As a result, in a case where the learning unit 631 performs the reinforcement learning again using an updated training data set, new data is easily reflected in the reinforcement learning, and it is expected that the result of the reinforcement learning is improved.

In addition, a part of data is deleted from the training data set, thereby making it possible not only to reduce the data size of the training data set, but also to make a storage capacity required for storage of the training data set relatively small. Furthermore, in terms of reduction in the data size of the training data set, in a case where the learning unit 631 performs reinforcement learning using the training data set obtained after data reduction, it is expected that the time required for learning becomes relatively short, for example, the learning result converges in a relatively short time.

The learning unit 631 can be implemented by using, for example, the function of the learning unit 191 in FIG. 1. The evaluation unit 632 can be implemented by, for example, using the function of the evaluation unit 192 in FIG. 1. The processing execution unit 633 can be implemented by using, for example, the function of the processing execution unit 193 in FIG. 1.

The processing execution unit 633 may select one or more pieces of data among the data included in a training data set, which is a data set used for reinforcement learning based on the evaluation on the learning result and the evaluation on the degree of influence, and may perform, based on the selected data, adjustment on at least one of a control target, which is a target of the reinforcement learning, and an operation environment of the control target.

As a result, the processing device 630 can automatically adjust at least one of the control target and the operation environment of the control target. For example, the processing device 630 can refer to data having a strong degree of influence on the result of the reinforcement learning in a case where the result of the reinforcement learning is good, and can adjust the setting of the control target or the setting for the operation environment of the control target so as to reproduce the “state” in a case where the result of the reinforcement learning is good.

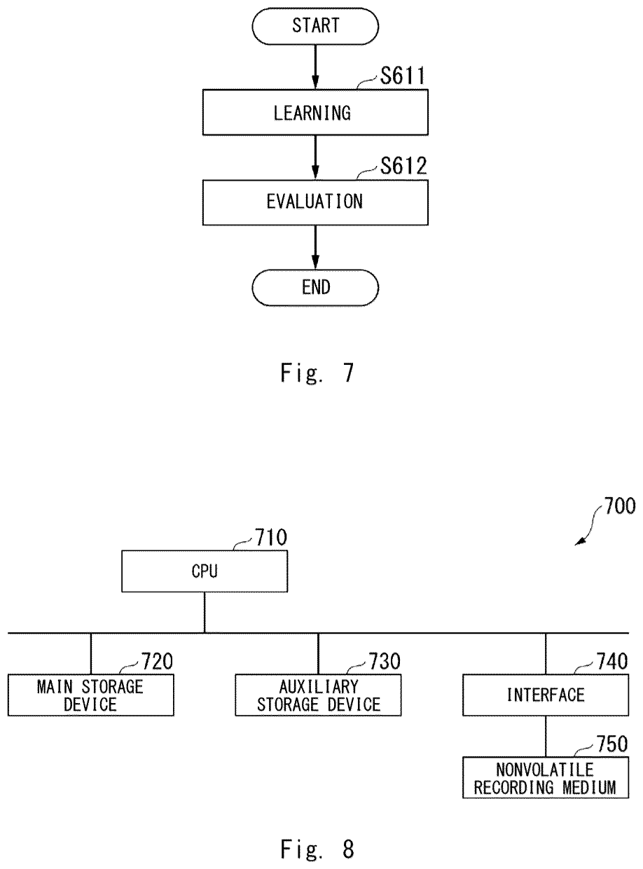

FIG. 7 is a diagram illustrating an example of a procedure of processing in a data analysis method according to the example embodiment. The data analysis method illustrated in FIG. 7 includes performing learning (step S611) and performing evaluation (step S612).

In performing learning (step S611), a computer performs reinforcement learning of updating a policy function using an evaluation function including a value function and updating the value function using the evaluation function including the policy function.

In performing the evaluation (step S612), the computer evaluates a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

According to the data analysis method illustrated in FIG. 7, it is possible to evaluate the degree of influence of individual data used for reinforcement learning on a learning result.

FIG. 8 is a schematic block diagram illustrating a configuration of a computer according to at least one example embodiment.

In the configuration illustrated in FIG. 8, a computer 700 includes a CPU 710, a main storage device 720, an auxiliary storage device 730, an interface 740, and a nonvolatile recording medium 750.

Any one or more of the data analysis device 100, the data analysis device 610, the display device 620, and the processing device 630 described above or a part thereof may be mounted in the computer 700. In that case, the operation of each processing unit described above is stored in the auxiliary storage device 730 in the form of a program. The CPU 710 reads the program from the auxiliary storage device 730, loads the program in the main storage device 720, and executes the above-described processing according to the program. In addition, the CPU 710 secures a storage area corresponding to each of the above-described storage units in the main storage device 720 according to the program. Communication between each device and another device is executed by allowing the interface 740 having a communication function to perform communication under the control of the CPU 710.

In a case where the data analysis device 100 is mounted in the computer 700, the operation of the control unit 190 and each unit thereof is stored in the auxiliary storage device 730 in the form of a program. The CPU 710 reads the program from the auxiliary storage device 730, loads the program in the main storage device 720, and executes the above-described processing according to the program.

Further, the CPU 710 secures a storage area of the storage unit 180 in the main storage device 720 according to the program. Communication with another device by the communication unit 110 is executed by allowing the interface 740 having a communication function to be operated under the control of the CPU 710. The display of various images by the display unit 120 is executed by allowing the interface 740 including a display device to display various images under the control of the CPU 710. The reception of a user operation by the operation input unit 130 is executed when the interface 740 includes an input device and receives the user operation under the control of the CPU 710.

In a case where the data analysis device 610 is mounted in the computer 700, the operations of the learning unit 611 and the evaluation unit 612 are stored in the auxiliary storage device 730 in the form of a program. The CPU 710 reads the program from the auxiliary storage device 730, loads the program in the main storage device 720, and executes the above-described processing according to the program.

In addition, the CPU 710 secures a storage area for the data analysis device 610 to perform processing in the main storage device 720 according to the program. Communication between the data analysis device 610 and another device is executed by allowing the interface 740 having a communication function to be operated under the control of the CPU 710. The interaction between the data analysis device 610 and the user is executed when the interface 740 includes a display device and an input device, displays various images under the control of the CPU 710, and receives a user operation.

In a case where the display device 620 is mounted in the computer 700, the operation of the display device 620 is stored in the auxiliary storage device 730 in the form of a program. The CPU 710 reads the program from the auxiliary storage device 730, loads the program in the main storage device 720, and executes the above-described processing according to the program.

In addition, the CPU 710 secures a storage area for the display device 620 to perform processing in the main storage device 720 according to the program. Communication between the display device 620 and another device is executed by allowing the interface 740 having a communication function to be operated under the control of the CPU 710. The interaction between the display device 620 and the user is executed when the interface 740 includes a display device and an input device, displays various images under the control of the CPU 710, and receives a user operation.

In a case where the processing device 630 is mounted in the computer 700, the operations of the learning unit 631, the evaluation unit 632, and the processing execution unit 633 are stored in the auxiliary storage device 730 in the form of a program. The CPU 710 reads the program from the auxiliary storage device 730, loads the program in the main storage device 720, and executes the above-described processing according to the program.

In addition, the CPU 710 secures a storage area for the processing device 630 to perform processing in the main storage device 720 according to the program. Communication between the processing device 630 and another device is executed by allowing the interface 740 having a communication function to be operated under the control of the CPU 710. The interaction between the processing device 630 and the user is executed when the interface 740 includes a display device and an input device, displays various images under the control of the CPU 710, and receives a user operation.

Any one or more of the above-described programs may be recorded in the nonvolatile recording medium 750. In this case, the interface 740 may read the program from the nonvolatile recording medium 750. Then, the CPU 710 may directly execute the program read by the interface 740, or may temporarily store and execute the program in the main storage device 720 or the auxiliary storage device 730.

Note that a program for executing all or part of the processing performed by the data analysis device 100 and the data analysis device 610 may be recorded in a computer-readable recording medium, and the processing of each unit may be performed by causing a computer system to read and execute the program recorded in the recording medium. Note that the “computer system” here includes hardware such as an OS and peripheral devices.

Furthermore, the “computer-readable recording medium” refers to a portable medium such as a flexible disk, a magneto-optical disk, a read only memory (ROM), and a compact disc read only memory (CD-ROM), and a storage device such as a hard disk built in a computer system. In addition, the program may be provided for implementing a part of the functions described above, and the functions described above may be implemented in combination with a program already recorded in the computer system.

Although an example embodiment of the present invention has been described in detail with reference to the drawings, a specific configuration is not limited to the example embodiment and includes design and the like within a range not departing from the gist of the present invention.

Some or all of the above-described example embodiments may be described as the following Supplementary Notes, but are not limited to the following Supplementary Notes.

### (Supplementary Note 1)

A data analysis device including:
a learning means for performing reinforcement learning of updating a policy function using an evaluation function including a value function and updating the value function using the evaluation function including the policy function; and
an evaluation means for evaluating a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

### (Supplementary Note 2)

The data analysis device according to supplementary note 1, in which
the learning means acquires any one of pieces of data included in a training data set serving as a data set used for the reinforcement learning, selects a learning mask corresponding to the acquired data from among the learning masks configured to uniquely designate, for each data included in the training data set, a partial model excluding a part of a machine learning model forming the policy function and a partial model excluding a part of a machine learning model forming the value function, and updates, using the acquired data, a value of a parameter of the partial model of the machine learning model forming the policy function and a value of a parameter of the partial model of the machine learning model forming the value function in a state in which the selected learning mask is applied to the machine learning model forming the policy and the machine learning model forming the value function, and
the evaluation means evaluates the degree of influence of the data to be evaluated on the learning result by using an evaluation value obtained by evaluating the learning result of the reinforcement learning as an evaluation value of the learning result in a case where the reinforcement learning is performed using the data set not including the data to be evaluated in a state in which an evaluation mask is applied to the machine learning model forming the policy and the machine learning model forming the value function, the evaluation mask being configured such that a portion subjected to exclusion in the learning mask corresponding to one piece of data to be evaluated selected from the data included in the training data set is not subjected to exclusion and all or a part of the portion not subjected to the exclusion in the learning mask is subjected to exclusion.

### (Supplementary Note 3)

A data analysis method including:
performing, by a computer, reinforcement learning of updating a policy function using an evaluation function including a value function and updating the value function using the evaluation function including the policy function; and
evaluating, by the computer, a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

### (Supplementary Note 4)

A data analysis method including:
performing, by a computer, reinforcement learning of updating a policy function using an evaluation function including a value function and updating the value function using the evaluation function including the policy function; and
evaluating, by the computer, a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

### (Supplementary Note 5)

A processing device including:
a learning means for performing reinforcement learning of updating a policy function using an evaluation function including a value function and updating the value function using the evaluation function including the policy function;
an evaluation means for evaluating a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated; and
a processing execution means for selecting, based on the evaluation on the learning result and the evaluation of the degree of influence, a part of data among the data included in a training data set serving as a data set used for the reinforcement learning, and deleting the selected data from the training data set.

### (Supplementary Note 6)

A processing device including:
a learning means for performing reinforcement learning of updating a policy function using an evaluation function including a value function and updating the value function using the evaluation function including the policy function;
an evaluation means for evaluating a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated; and
a processing execution means for selecting, based on the evaluation on the learning result and the evaluation of the degree of influence, one or more pieces of data among the data included in a training data set serving as a data set used for the reinforcement learning, and performing, based on the selected data, adjustment on at least one of a control target serving as a target of the reinforcement learning and an operation environment of the control target.

### (Supplementary Note 7)

A display device including a display means for displaying a degree of influence of data included in a training data set serving as a data set used for reinforcement learning on a result of the reinforcement learning.

### (Supplementary Note 8)

A display device including a display means for displaying a degree of influence of data included in a training data set serving as a data set used for reinforcement learning on a result of the reinforcement learning and evaluation on the result of the reinforcement learning.

### (Supplementary Note 9)

A display device including a display means for displaying a degree of influence of data included in a training data set serving as a data set used for reinforcement learning on a result of the reinforcement learning, evaluation on the result of the reinforcement learning, and a message regarding deletion of a part of data among the data included in the training data set.

### (Supplementary Note 10)

A display device including a display means for displaying, for each of a plurality of control targets, evaluation on a result of reinforcement learning for the control target, displaying a degree of influence of data included in a training data set serving as a data set used for the reinforcement learning on the result of the reinforcement learning in a selectable manner for each of the control targets, and displaying an inquiry as to whether to delete a part of data selected based on the degree of influence on the result of the reinforcement learning for a selected control target among the data included in the training data set.

### (Supplementary Note 11)

A display device including a display means for displaying a degree of influence on a result of reinforcement learning for each piece of data and for each repetition of evaluation in a form of a heat map in a coordinate space formed of a first axis indicating a numerical value for identifying data included in a training data set serving as a data set used for the reinforcement learning and a second axis indicating the number of times of repetition of the evaluation on the degree of influence on the result of the reinforcement learning of each data included in the training data set.

### (Supplementary Note 12)

A display device including a display means for displaying a heat map indicating a degree of influence on a result of reinforcement learning for each piece of data and for each repetition of evaluation in a coordinate space formed of a first axis indicating a numerical value for identifying data included in a training data set serving as a data set used for the reinforcement learning and a second axis indicating the number of times of repetition of the evaluation on the degree of influence of each piece of data included in the training data set on the result of the reinforcement learning by including display of a portion selected according to the degree of influence in the heat map, and displaying an inquiry as to whether to delete data of the selected portion from the training data set.

### (Supplementary Note 13)

A display device including a display means for displaying evaluation on a result of reinforcement learning in each repetition of evaluation of a degree of influence on the result of the reinforcement learning of each data included in a training data set serving as a data set used for the reinforcement learning, displaying a heat map indicating a degree of influence on the result of the reinforcement learning for each data and for each repetition of the evaluation in a coordinate space formed of a first axis indicating a numerical value for identifying the data included in the training data set and a second axis indicating the number of times of repetition of the evaluation of the degree of influence by including display of a portion selected according to the degree of influence in the heat map, and displaying an inquiry as to whether to delete data of the selected portion from the training data set.

### (Supplementary Note 14)

A display device including a display means for displaying, for each of a plurality of control targets, evaluation on a result of reinforcement learning in each repetition of evaluation of a degree of influence on the result of the reinforcement learning of each data included in a training data set serving as a data set used for the reinforcement learning for the control target, displaying a heat map indicating the degree of influence on the result of the reinforcement learning for each data and for each repetition of the evaluation in a coordinate space formed of a first axis indicating a numerical value for identifying the data included in the training data set and a second axis indicating the number of times of repetition of the evaluation of the degree of influence by including display of a portion selected according to the degree of influence in the heat map for each control target in a selectable manner, and displaying an inquiry as to whether to delete data of the selected portion in the selected heat map from the training data set.

### INDUSTRIAL APPLICABILITY

The present invention may be applied to a data analysis device, a data analysis method, and a recording medium.

### REFERENCE SIGNS LIST

100, 610 data analysis device
110 communication unit
120 display unit
130 operation input unit
180 storage unit
190 control unit
191, 611 learning unit
192, 612 evaluation unit
193 processing execution unit
620 display device
630 processing device

What is claimed is:

1. A data analysis device comprising:
at least one memory configured to store instructions; and
at least one processor configured to execute the instructions to:
perform reinforcement learning of updating a policy function using an evaluation function including a value function and updating the value function using the evaluation function including the policy function; and
evaluate a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

2. The data analysis device according to claim 1, wherein the at least one processor is configured to execute the instructions to:
acquire any one of pieces of data included in a training data set serving as a data set used for the reinforcement learning, selects a learning mask corresponding to the acquired data from among learning masks configured to uniquely designate, for each data included in the training data set, a partial model excluding a part of a machine learning model forming the policy function and a partial model excluding a part of a machine learning model forming the value function, and updates, using the acquired data, a value of a parameter of the partial model of the machine learning model forming the policy function and a value of a parameter of the partial model of the machine learning model forming the value function in a state in which the selected learning mask is applied to the machine learning model forming the policy function and the machine learning model forming the value function, and
evaluate the degree of influence of the data to be evaluated on the learning result by using an evaluation value obtained by evaluating the learning result of the reinforcement learning as an evaluation value of the learning result in a case where the reinforcement learning is performed using the data set not including the data to be evaluated in a state in which an evaluation mask is applied to the machine learning model forming the policy and the machine learning model forming the value function, the evaluation mask being configured such that a portion subjected to exclusion in the learning mask corresponding to one piece of data to be evaluated selected from the data included in the training data set is not subjected to exclusion and all or a part of the portion not subjected to the exclusion in the learning mask is subjected to exclusion.

3. (canceled)

4. A computer implemented method for data analysis comprising:
performing reinforcement learning of updating a policy function using an evaluation function including a value function and updating the value function using the evaluation function including the policy function; and
evaluating a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.

5. A non-transitory recording medium storing a program therein, the program causing a computer to execute:
reinforcement learning of updating a policy function using an evaluation function including a value function and updating the value function using the evaluation function including the policy function; and
evaluation on a degree of influence of data to be evaluated on a learning result by using evaluation on a learning result in a case where the reinforcement learning is performed using a data set including the data to be evaluated and evaluation on a learning result in a case where the reinforcement learning is performed using a data set not including the data to be evaluated.
